(19) United States
(12) Patent Application Publication
(10) Pub. No.: US 2011/0167214 A1
(43) Pub. Date: Jul. 7, 2011

(54) Method And Apparatus To Manage Non-Volatile Disk Cache

(76) Inventor: Leonard Russo, Tomball, TX (US)

(21) Appl. No.: 13/062,787

(22) PCT Filed: Sep. 15, 2008
(86) PCT No.: PCT/US08/76384

§ 371 Date: Mar. 8, 2011

(51) Int. Cl. G06F 12/00; G06F 12/08

(52) U.S. Cl. 711/113; 711/112; 711/E12.019; 711/E12.022

(57) ABSTRACT

The present invention provides a method and an apparatus to manage non-volatile (NV) memory as cache on a hard drive disk for data storage.

### BACKGROUND

Modern computers may have hard disk drives for permanent data storage and addressable dynamic memory from which to execute computer programs. There is a growing disparity between memory speed (e.g. 5-70 ns for many of today's memory products to access one byte in the memory) and disk speed (e.g. 2-20 ms for many of today's hard disk drive products to access one byte on the rotating hard disk media). When a computer program is executed from the addressable dynamic memory, the execution may be at memory speed. However, if there is a page fault, for example, the computer program may need to access a piece of data on the hard disk that has not been loaded into the addressable dynamic memory, then the computer program may have to wait for the data to be loaded and the execution speed may reduce to disk speed. Because addressable dynamic memory may be smaller than typical hard disk drive in capacity, addressable dynamic memory may contain a smaller set of data on a typical hard disk drive and may need to access the hard disk drive from time to time. As a result, the overall speed of the memory system may be affected disadvantageously by the increasing disparity between memory speed and disk speed. Although there is dynamic random-access memory (DRAM) on a modern hard disk drive as disk cache to serve as a buffer, the disparity may still affect the overall speed of the memory system on a computer system for similar reasons. In addition, the hard disk drive may also consume a significant share of the power used by a computer system, which contributes to thermal load and leads to the installation of noisy cooling fans.

Methods have been proposed before to reduce power consumption and to improve the read/write performance of hard disk drives using non-volatile memory. One example is disclosed in U.S. Pat. No. 7,082,495 to DeWhitt et al. The '495 patent teaches a software method to be implemented by an operating system. The operating system provides a list of data to be put in non-volatile (“NV”) memory. The data includes data to be pinned in the NV memory and data that is dynamic. Pinned data persists in NV memory until the operating system commands it to be flushed. Dynamic data is data that can be prioritized by the operating system but are otherwise controllable by the hard drive controller. The NV memory is used during the operating system operations to buffer temporary files. This reduces the number of times the disk drive is spun up when the system is operating. During operation, the operating system predicts what data a user will need based upon usage scenarios and provides a list of blocks of data for the hard drive pre-cache so that the user may not have to wait for the hard disk drive to be accessed. Some data may be needed frequently or needed for booting. The NV memory has an array of cached memory blocks with the ability to pin individual blocks. A pinned block is held in the cache until the operating system unpins it. The memory may be pinned in such a way that it persists in NV memory between boots of the computer system. The operating system determines what data should be permanently stored in NV memory and sends a list of blocks to the hard drive. The hard drive pins those blocks in NV memory until the operating system releases the blocks.

In addition, Microsoft implemented software features such as Vista SuperFetch and ReadyBoost by utilizing NV memory to boost disk read/write performance.

### SUMMARY

The present invention provides a method and an apparatus to manage non-volatile (NV) memory as cache on a hard disk drive, without additional software features, such as those disclosed by the '495 patent, from an operating system.

### BRIEF DESCRIPTION OF THE DRAWINGS

Embodiments will now be described in connection with the associated drawings, in which:

FIG. 1 depicts an exemplary embodiment of the current invention.

FIG. 2 depicts an exemplary embodiment of the current invention.

### DETAILED DESCRIPTION OF THE EMBODIMENTS

Exemplary embodiments are discussed in detail below.

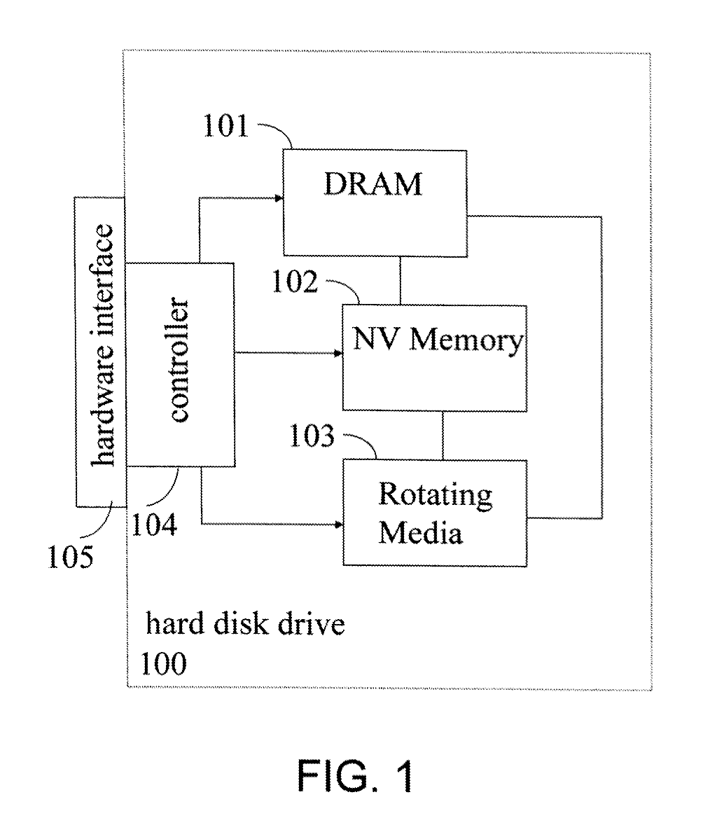

FIG. 1 depicts an exemplary embodiment of the current invention. Hard disk drive 100 may comprise: at lease one non-volatile (NV) memory 102; a plurality of rotating hard disk media 103; a controller 104 in communication with the NV memory 102 and the rotating media 103; and a hardware interface 105 for use with a standardized hard disk drive interface protocol. Hard disk drive 100 may further comprise an array of dynamic random access memory (DRAM) 101.

When a computer is executing a computer program, the computer may need to access data on the hard disk drive 100. For example, a page fault may be generated, by an operating system on the computer, in reference to data located on the rotating hard disk media 103. At least a portion of the data in use by the computer may be fetched from the rotating hard disk media 103 to NV memory 102. The presence of the NV memory 102 may effectively increase the available buffer size for the computer to accommodate larger size files or larger number of computer programs concurrently being executed.

During execution, the computer program may modify part of the data in use. The operating system may keep track of which portion of the data has been modified by logic data structures in the dynamic memory on the computer. The logic data structure may be a look-up table to record of pages that has been modified. However, tracking which portion of the data on the NV memory has been modified by logic data structures in the dynamic memory on the computer may give rise to certain undesirable situations. For example, in a sudden power outage, the logic data structure, in the dynamic memory of the computer, for tracking NV memory usage may vanish, thus neutralizing, at least part of, the benefits of using NV memory as an intermediate buffer for data storage.

The controller 104 may be responsible for managing data in the NV memory 102 without an over reliance on additional features, for example, those disclosed by the '495 patent, implemented by the operating system on the computer. The tracking of data in the NV memory 102 may be performed on the hard disk drive 100. For example, by the hard disk drive's controller hardware, or firmware, or a combination thereof. For example, registers in controller 104 may be used to track the status (e.g. “1” for modified, “0” for unmodified) of data in the NV memory 102. For example, embedded firmware on the hard disk drive may also be used to track the status data in the NV memory 102. The firmware may reside on controller 104. For example, the firmware may populate a table structure as data is loaded, for example, sequentially from the rotating hard disk media 103. The table structure may contain a flag field that indicates the modification status of a block of data, for example, in units of 512 bytes. If the operating system on the computer modifies a portion of the data that was loaded in the NV memory 102, the firmware may mark the corresponding flag fields. The firmware may have access to non-volatile hardware, for example, on the controller 104, to store at least part of the table structure to ensure data integrity.

Operating systems may have novel features such as write-behind policies. For example, the write operations of a computer program may not be executed by the operating system until the computer program is terminating or a conflict is imminent in a networked and/or shared environment. The write-behind policies may give a user running the computer program the apparent impression of higher execution speed and/or faster response. In the context of using on-disk NV memory 102 as an intermediate buffer for data storage, leaving management of data on the NV memory completely to an operating system that also implements write-behind policies may warrant further consideration. For example, in the event of a sudden power outage, information may be lost. Reserving an appropriate amount of intelligence for the hard disk drive 100 may further improve data integrity and I/O performance while maintaining those write-behind policies.

The controller 104 may be further adapted to flush data in the NV memory 102 upon receiving a command from the operating system on the computer 201 to commit data to permanent storage. The NV memory 102 may serve as an intermediate buffer to hold data that may be accessed by a write-behind policy, until the operating system sends a command to the controller 104 to commit data to permanent storage.

In addition, the controller 104 is further adapted to flush data that is modified in the NV memory 102 to the rotating hard disk media 103. If data is not modified in the NV memory 102, then it may not be committed to rotating hard disk media 103, thus saving unnecessary disk seek and write time as well as power that may be consumed on these unnecessary activities.

For example, programmable logic may be employed in the controller 104 to flush modified data in the NV memory 102 to the rotating hard disk media 103 once requested by the operating system on the computer 201.

After data in the NV memory 102 is flushed to the rotating hard disk media 105, the hard disk drive controller 104 may either keep the data in the NV memory 102 or clear the data in the NV memory 102. Keeping the data may facilitate access to the data next time the data is in need by the computer. For example, data related to booting may reside on the NV memory 102 to enable faster booting process next time. Clearing the data may leave more space on the NV memory 102 for other programs to use.

The hardware interface 105 may operate on one of the following standardized interface protocols for connecting storage devices: Advanced Technology Attachment (ATA), Integrated Drive Electronics (IDE), Advanced Technology Attachment Packet Interface (ATAPI), parallel ATA (PATA), serial ATA (SATA), Small Computer System Interface (SCSI), Fiber Channel, or variations thereof.

Maximum read/write speed achievable on current hard disk drive without on-disk NV memory is attained under a burst mode. For example, a 2½ inch hard disk drive containing 8-16 MB of DRAM of disk cache and rotating media of much larger size can reach a peak transfer rate of up to 50 MB/s under burst mode with a corresponding sustainable data volume of up to 200-300 MB. This is largely due to the limited size of the DRAM disk cache. With the introduction of NV cache that is relatively larger than the DRAM and relatively faster than the rotating media in the present invention, substantial improvement in the sustainable data volume may be achieved. This improvement may be useful in a variety of data-intensive applications, for example, transferring large files for enterprise databases or individual home-entertainment.

The current invention may also improve data integrity and consistency. Hard disk drives with only DRAM disk cache and no NV cache may lose data due to a sudden power outage during an operation of data commit to disk. NV memory 102 on hard disk drive 100 may not need power to retain data and therefore may not be vulnerable to sudden power outage and may remove the additional cost and complexity of uninterrupted power supply (UPS) systems.

The current invention may lead to substantial reduction in hard disk drive power consumption as a result of, inter alias, less need to access rotating media.

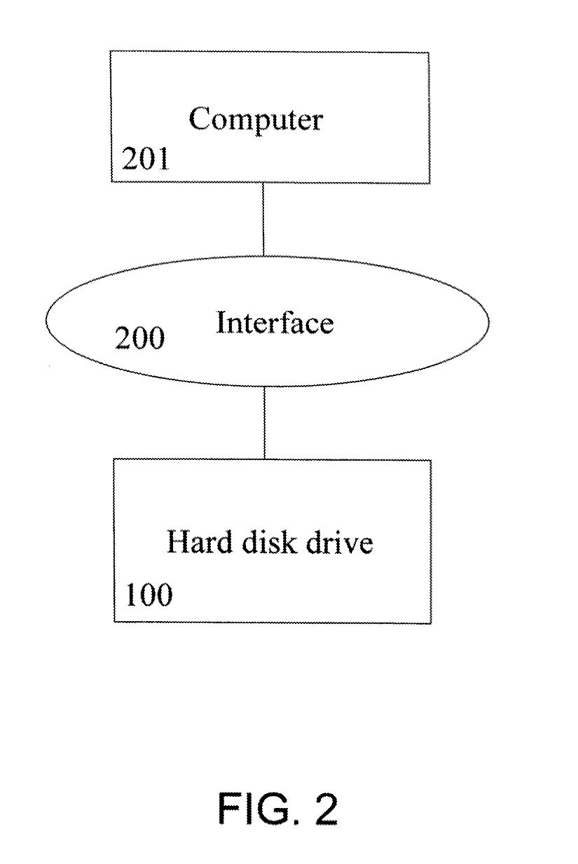

FIG. 2 depicts an exemplary embodiment of the current invention. Computer 201 communicates to hard disk 100 via an interface 200. Computer 201 may be a single computer or a computer system. Interface 200 may enable an operating system on computer 201 to use the hard disk drive 100. Interface 200 comprises: a first set of commands to fetch data from the rotating hard disk media 103 to the NV memory 102; a second set of commands to transfer the fetched data to the DRAM on the hard disk drive 100 or to the computer 201; and a third set of commands to flush data stored in the NV memory 102 to the rotating hard disk medium 103 for permanent storage. The third set of commands to flush data in the NV memory 102 comprises both the functions of clearing and keeping data in the NV memory 102 after flushing. For example, to flush the NV memory 102 on a hard disk drive 100, a special command may be implemented.

The details of the command structure for 28-bit logic block addressing (LBA) for Advanced Technology Attachment (ATA), Integrated Drive Electronics (IDE), Advanced Technology Attachment Packet Interface (ATAPI), and parallel ATA (PATA) hard disk drives are noted below:

Register:

Feature: 0x22

Sector Count 0x01 or 0x00

LBA Low: Reserved

LBA Mid: Reserved

LBA High: Reserved

Device: 0x10 or 0x00 are acceptable

Command: 0xE7

When a hard disk drive 100 places in the NV memory 102 at least part of a file in use by a program on computer 201, the computer 201 may modify a portion of the file. By setting the Sector Count register to 0x01, the hard disk drive 100 may commit the modified data in the NV memory 102 to the rotating hard disk media 103 and then may clear the data in the NV memory 102. If the Sector count register is set to 0x00, the hard disk drive 100 may commit the modified data in the NV memory 102 to the rotating hard disk rotating media 103 and then may keep the data in the NV memory 102.

The space limit, for example, measured by the number of sectors of 512 bytes addressable by 28-bit LBA is a maximum of 268,435,456 sectors or 137.4 gigabytes. In 2001, 48-bit LBA was introduced. The additional 20 bits allow the interface to address a binary million more times of space, raising the limit to 144 petabytes (144,000,000 gigabytes).

The details for the command structure vary accordingly and the following command structure is for 48 bit support:

Register:

Feature(current/previous): 0x44/Reserved

Sector Count(current/previous): 0x01 or 0x00/Reserved

LBA Low(current/previous): Reserved/Reserved

LBA Mid(current/previous): Reserved/Reserved

LBA High(current/previous): Reserved/Reserved

Device: 0x10 or 0x00 are acceptable

Command: 0xEA

When a hard disk drive 100 places in the NV memory 102 at least part of a file in use by a program on computer 201, the computer 201 may modify a portion of the file. Similarly, by setting the Sector Count register to 0x01, the hard disk drive 100 may commit the modified data in the NV memory 102 to the rotating hard disk media 103 and then may clear the data in the NV memory 102. If the Sector count register is set to 0x00, the hard disk drive 100 may commit the modified data in the NV memory 102 to the rotating hard disk media 103 and then may keep the data in the NV memory 102.

A person of ordinary skill in the art may further adapt the structure for an interface with a LBA, using even more bits, by following the true spirit of the current invention.

The cited examples are for Advanced Technology Attachment (ATA), Integrated Drive Electronics (IDE), Advanced Technology Attachment Packet Interface (ATAPI), and parallel ATA (PATA) hard disk drives. However, the current invention may be generally applied to other hard disk drives including Small Computer System Interface (SCSI), serial ATA (SATA), Fiber Channel, etc. For example, SATA is serial ATA that performs serial transport of data and therefore the extension to SATA is feasible.

The present invention may also apply to Redundant Array of Independent Disks (RAID) as RAID is an array of hard disk drives.

Using the specified commands noted above may allow an operating system on computer 201 to apply novel algorithms that may allow, for example, the most frequently used data or the most recently used data, to be kept in NV memory 102 after flushing modified portions to the rotating media 103, thus enabling advantageous caching. Furthermore, the freeing up of the NV memory 102 on the hard disk drive 100 may enable specific applications or data from the rotating media 103 to be loaded into the NV memory 102. This may be in line with, for example, an operating system policy that evicts least recently used data from NV memory 102. In addition to making the NV memory 102 available for other applications, removing data from the NV memory 102 may ensure that modified data is written to the rotating hard disk media 103 as the permanent storage location.

The use of the specified commands noted above may be compatible in syntax with current Flush Cache command for current hard disk drives without NV memory to commit data in their dynamic RAM cache to the hard drives rotating media. The syntax compatibility may lead to easy integration of the hard disk drive 100 with an operating system. Furthermore, the syntax compatibility may make hard disk drive 100 operable even by an operating system designed to operate current hard disk drives without NV memory. For example, the flush disk command may be performed, as a default, by controller 104 to commit modified data to rotating hard disk media and then clear the data in the NV memory 102. Thus, the commands noted above may offer compatibility for current operating system software designed to operate current hard disk drives without NV memory to use a hard disk drive 100 in FIG. 1.

Vista SuperFetch and ReadyBoost are operating system features from Microsoft that manage a NV Flash device as cache for a hard disk drive. For their products to work, the NV Flash device and hard disk drive may not reside on the same device, as their invention is purely based on software associated with their operating system.

In contrast to the '495 patent which may attempt to put all the intelligence into an operating system, the invention may reserve a reasonable amount of the intelligence for the hard disk drive itself. For the reasons set forth above, the current invention may reap the benefits associated with hard disk drive 100 having on-disk NV memory 102 without an over-reliance on an operating system that may become overly complicated to maintain. The benefits that may be achieved include improvements in, for example, maximal read-write disk speed, sustainable data volume, data integrity and consistency, power consumption, etc.

The examples and embodiments described herein are non-limiting examples.

The invention is described in detail with respect to exemplary embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

What is claimed is:

1. A method to use a hard disk drive for data storage, comprising:
receiving commands from an operating system on a computer;
storing, in non-volatile (NV) memory of the hard disk drive, at least a portion of the data corresponding to a file in use by the computer;
tracking, on the hard disk drive, which part of the data stored in the NV memory has been modified by the operating system on the computer; and
flushing, in response to a command received from the operating system on the computer, the data in the NV memory to commit the modified data to rotating hard disk media.

2. The method as set forth in claim 1, wherein the tracking is performed by at least one of internal controller hardware and embedded firmware on the hard disk drive.

3. The method as set forth in claim 1, wherein the flushing comprises clearing the data in the NV memory of the hard disk drive after committing the modified data to the rotating hard disk media.

4. The method as set forth in claim 1, wherein the flushing comprises keeping the data in the NV memory of the hard disk drive after committing the modified data to the rotating hard disk media.

5. A hard disk drive for data storage used by a computer comprising:
at least one non-volatile (NV) memory to store at least a portion of the data corresponding to a file in use by the computer;
a plurality of rotating hard disk media;
a controller in communication with the NV memory, the rotating hard disk media, and the computer, wherein the controller is configured to receive and respond to interface commands from an operating system on the computer which enable the computer to use the hard disk drive, the interface commands comprising a Flush Cache command that is compatible in syntax with the Flush Cache command from a hard disk drive without NV memory; and
a hardware interface to implement standardized protocols to connect storage devices.

6. The hard disk drive as set forth in claim 5, further comprises at least one of internal controller hardware and embedded firmware that track which part of the data in the NV memory of the hard disk drive has been modified.

7. The hard disk drive as set forth in claim 5, wherein the controller is further adapted to flush the data in the NV memory of the hard disk drive in response to a command received from the operating system to commit data to permanent storage.

8. The hard disk drive as set forth in claim 7, wherein the controller is further adapted to commit modified data in the NV memory of the hard disk drive to the rotating hard disk media.

9. The hard disk drive as set forth in claim 5, wherein the Flush Cache command further includes an option to clear the data in the NV memory of the hard disk drive after committing modified data to the rotating hard disk media.

10. The hard disk drive as set forth in claim 5, wherein the Flush Cache command further includes an option to keep the data in the NV memory of the hard disk drive after committing modified data to the rotating hard disk media.

11. A computer or computer system comprising:
a hard disk drive that further comprises:
at least one non-volatile (NV) memory to store at least a portion of the data corresponding to a file in use by the computer;
a plurality of rotating hard disk media;
a controller in communication with the NV memory, the rotating hard disk media, and the computer, wherein the controller is configured to receive and respond to interface commands from an operating system on the computer which enable the computer to use the hard disk drive, the interface commands comprising a Flush Cache command that is compatible in syntax with the Flush Cache command from a hard disk drive without NV memory; and
a hardware interface to implement standardized protocols to connect storage devices.

12. The computer or computer system as set forth in claim 11, wherein of the hard disk drive is delegated by the computer with the task of tracking modification status of the data in the NV memory of the hard disk drive

13. The computer or computer system as set forth in claim 12, wherein the task of tracking modification status of the data in the NV memory of the hard disk drive is accomplished by at least one of internal controller hardware and embedded firmware on the hard disk drive.

14. The computer or computer system as set forth in claim 11, wherein an operating system on the computer sends the Flush Disk command to the hard disk drive to commit data in the NV memory of the hard disk drive to the rotating hard disk media.

15. The computer or computer system as set forth in claim 14, wherein the Flush Disk command causes the data in the NV memory of the hard disk drive that is modified by the operating system to be committed to the rotating hard disk media.
